(19) United States
(12) Patent Application Publication
(10) Pub. No.: US 2025/0208924 A1
(43) Pub. Date: Jun. 26, 2025

(54) Systems and Methods for Heterogeneous Model Parallelism and Adaptive Graph Partitioning

(71) Applicant: Advanced Micro Devices, Inc., Santa Clara, CA (US)

(72) Inventors: Viren Luke Radhakrishnan, Bangalore (IN); Arun Coimbatore Ramachandran, Bangalore (IN); Lalithnarayan Chandrashekar, Bangalore (IN); Prakash Sathyanath Raghavendra, Bangalore (IN)

(21) Appl. No.: 18/395,485

(22) Filed: Dec. 23, 2023

(51) Int. Cl. G06F 9/50

(52) U.S. Cl. CPC G06F 9/5066; G06F 9/5027

(57) ABSTRACT

Systems, apparatuses, and methods for adaptive graph repartitioning of a computational graph representing at least a portion of a neural network are described. Parallelization of a neural network model includes executing some partitions of a computational graph on accelerators while other partitions can be executed on a CPU. When executing these partitions using specific computing devices, operational parameters of different computing devices and overall availability of system resources can keep changing over time. Adaptive graph repartitioning includes repartitioning a computational graph that includes nodes representing various operations for a neural network model. Dynamic repartitioning of the graph partitions can be performed to better distribute load between devices for different conditions such as exploiting different device strengths, minimizing the idle time of the devices, and generating different partition configurations.

### BACKGROUND

### Description of the Related Art

Neural networks have emerged as powerful tools for solving complex tasks across a wide range of domains, including image and speech recognition, natural language processing, autonomous robotics, and medical diagnostics. These artificial neural networks are composed of interconnected layers of artificial neurons and are capable of learning and extracting complex patterns from data. They have achieved remarkable success in achieving human-level or even superhuman performance in various applications. Neural networks utilize multiple layers of models to produce an output, such as classifications, based on an input received. These layers may encompass hidden layers as well as an output layer. The output of each hidden layer serves as input for a subsequent layer, whether it's another hidden layer or the network's output layer. Each layer in the network processes input data using specific parameter values associated with that layer.

An individual computing device can handle the processing of layers within a neural network. This device can be equipped with a processor capable of conducting operations, like producing outputs at each layer based on inputs, and storing the resulting outputs in memory. Given the substantial volume and complexity of operations typically needed to generate these outputs in a neural network, a single computing device may require a considerable amount of time to process the network's layers. In order to reduce computation time, some systems may allow for custom partitioning techniques to be applied to computational graphs in neural network models and the assignment of subgraphs for execution on different computing devices. However, at runtime, the execution takes place in a linear fashion between devices. For instance, a subgraph executed by one computing device (e.g., an accelerator) is followed execution of another subgraph by another computing device. That is, at any given time, only one device is engaged while the other is idle. Consequently, such an approach does not truly exploit the parallelism of a heterogenous computing environment that might otherwise be achieved.

Therefore, there exists a need for an improved techniques for parallelism in heterogenous models, specifically tailored to computational graphs.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 illustrates an example flow diagram illustrating optimizing neural network models for execution on one or more computing devices.

FIG. 4 illustrates a block diagram illustrating partitioning of computational graphs of a neural network model.

FIG. 5 illustrates a block diagram elaborating task parameters for tasks in a pipeline.

FIG. 6 illustrates an example block diagram for adaptive graph repartitioning of a computational graph.

FIG. 7 illustrates an example adaptive graph repartitioning based on floating-point operations per second (FLOPS).

FIG. 8 illustrates an example method for adaptive repartitioning of computational graphs representing a neural network model.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for adaptive graph repartitioning of a computational graph representing a neural network are disclosed. In the context of Machine Learning (ML), neural networks are commonly used for inference (e.g., to perform classification or recognition based on previously trained parameters). By combining CPUs with acceleration/accelerator hardware, performance can be increased. CPUs can possess exceptional computational power and are highly efficient on Deep Neural Network (DNN) workloads. On the other hand, graphics processing units (GPUs) and other specially adapted hardware (e.g., accelerators including FPGA based systems) are capable of high levels of parallelism that can achieve high performance on various types of workloads. By combining these different types of computing devices, an opportunity for exploitation of heterogeneous computing between devices is possible. In one implementation, parallelization of the model is one way by which this computational power can be utilized. For example, some partitions of the graph can run on accelerators which are optimized for performing certain types of operations, while other partitions run on the CPU.

In one implementation, when executing these partitions using specific computing devices, operational parameters of different computing devices and overall availability of system resources can change over time. For example, idle times can change for a CPU when waiting for specific operational data. Similarly, computing resource availability can also change for accelerators processing a graph partition. Further, in some applications or domains, different combinations for performance and power can be required during execution of the various partitions of the graph. For example, based on varying input load levels for a given device, the amount of power consumed by the device can change. Further, some operations can require higher power consumption in order to maintain a desired level of performance.

Adaptive graph repartitioning includes repartitioning a computational graph that includes nodes representing various operations for a neural network model. For example, a graph can be grouped into partitions during an initial partitioning of the graph. Each such partition can then be assigned to a specific computing device for execution. In one implementation, dynamic repartitioning of the graph is performed to better exploiting different device strengths, minimizing the idle time of the devices, take into consideration availability of resources, and otherwise. In various implementations, repartitioning is performed without halting the inference server. These and other implementations are described herein.

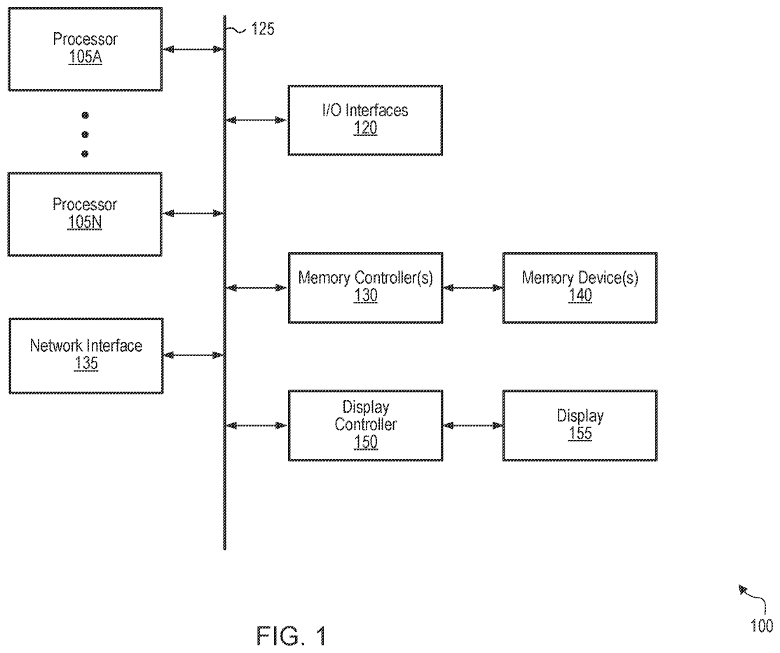

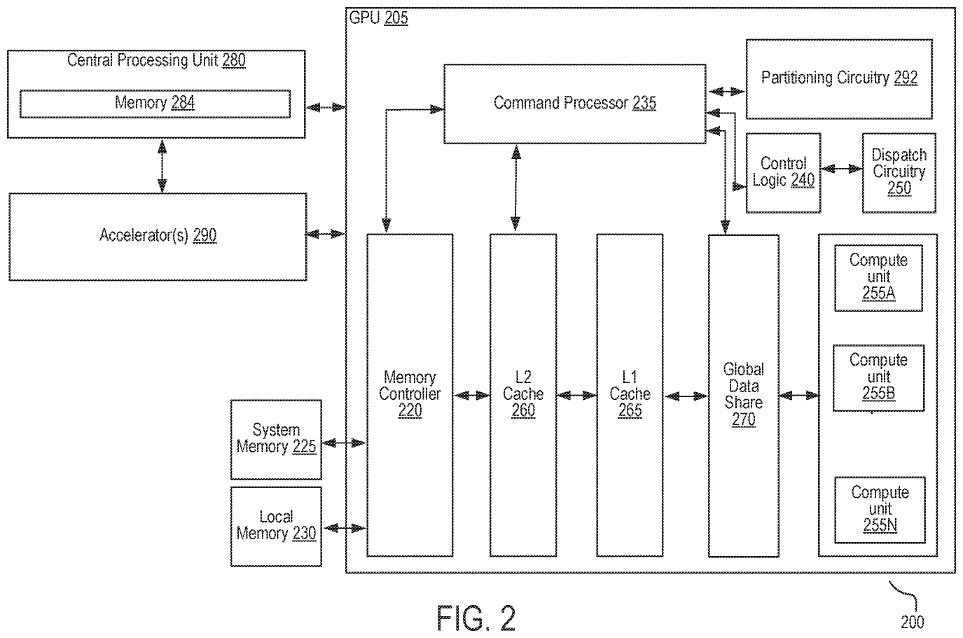

Referring now to FIG. 1, a block diagram of one implementation of a computing system 100 is shown. In an implementation, computing system 100 is configured to, amongst other functionalities, process and execute data corresponding to computational graphs for training neural networks using a machine learning training algorithm. As an example, this algorithm can involve calculating gradients of an objective function concerning each parameter of the neural network. System 100 is configured to partition computational graphs into subgraphs, where each subgraph contains one or more nodes of the original computational graph. This involves creating a specific subgraph for each identified node group. The system 100 is further configured to allocate the operations represented by the nodes within each subgraph to a selected computing device from available devices in a heterogenous computing environment for processing. The system 100 is further configured to repartition the computational graph to update the subgraphs and/or create additional subgraphs responsive to a repartitioning condition. The creation, assignment, and repartitioning of subgraphs is explained in detail with respect to subsequent FIGS. 2-8.

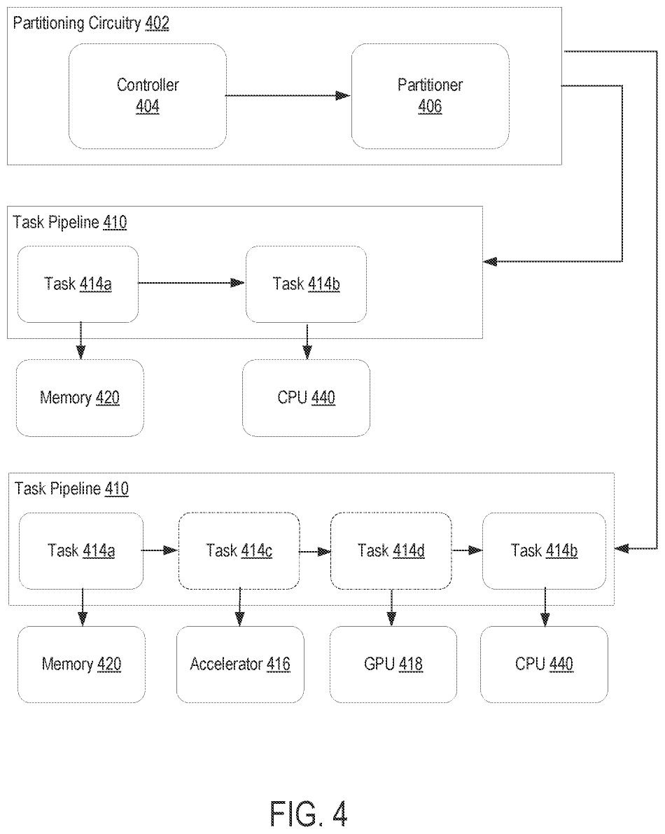

In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-6 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

Turning now to FIG. 2, a block diagram of an implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes partitioning circuitry 292. Central processing unit (CPU) 280 at least including memory 284 and one or more accelerators 290 including, for example, a deep neural network processing unit (DPU) with circuitry optimized for performing neural network related operations are depicted. Other implementations are contemplated.

In various implementations, computing system 200 executes any of various types of software applications. As part of executing a given software application, a host CPU 280 of computing system 200 launches kernels to be performed on GPU 205. Command processor 235 receives kernels from the host CPU 280 and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N. As described below, certain types of circuits are referred to as “units” (e.g., a decode unit, compute unit, an arithmetic logic unit, functional unit, etc.). Accordingly, the term “unit” or “units” also refers to circuits or circuitry unless otherwise indicated. In some implementations, system 200 is a system on a chip (SoC) with the components shown integrated on a single integrated circuit. In other implementations, system 200 is not an SoC and one or more of the components are separate integrated circuits, devices, or systems. Numerous such alternatives are possible and are contemplated.

In one implementation, system 200, during operation, receives requests from one or more client devices (not shown) to execute a computational graph. As described in the context of this disclosure, a “computational graph” (or simply “graph”) in a neural network is a graphical representation that illustrates the flow of operations or computations as data moves through the neural network. The graph is composed of nodes and edges, where nodes represent mathematical operations or transformations, and edges represent the data or tensors (e.g., vectors or arrays of values) flowing between these operations. For example, nodes typically represent operations like matrix multiplications, activation functions, or loss calculations. Edges can represent the intermediate data or tensors generated by these operations.

In an implementation, the request received from the client device can pertain to various tasks associated with the computational graph, such as conducting a neural network inference on given input, performing training operations for a neural network using a designated set of training data, or engaging in other specified neural network operations represented by the graph. Upon receiving the request, the system 200 acquires the data that describes the computational graph. In certain instances, this data is included in the request transmitted by the client. Alternatively, the request identifies the data associated with the graph, prompting the system 200 to retrieve the associated data from a memory (e.g., memory 230). As an example, this data may comprise an array detailing the nodes within the graph. In various implementations, each node comprises specific details, including the type of operation, a unique identifier, and a list of inbound and outbound edges linked to that node. Using the data, the system 200 can enhance the graph by adding nodes and edges, and creating a backward propagation path. This backward path includes operations within the neural network aimed at producing a gradient output for the given input.

In one implementation, the system 200 determines available computing devices that can be assigned to execute one or more tasks representing the computational graph. As used herein, a computing device is deemed as “available” or “idle” if it can accept additional tasks, such as queuing further operations for execution. Conversely, a device is “occupied,” if it is presently engaged in other tasks and cannot take on additional operations or is inaccessible for graph processing operations. In an implementation, the GPU 205, the CPU 280, and accelerators 290 can all be determined as candidates available for executing tasks representing the computational graph.

Based on the determination of available devices, partitioning circuitry 292 is configured to generate partitions (“subgraphs”) for one or more computational graphs such that each subgraph can be assigned to a respective computing device. In an implementation, partitioning circuitry 292 divides the computational graph into multiple subgraphs, each consisting of one or more nodes from the original computational graph. In certain scenarios, these subgraphs can be derived by splitting pairs of adjacent nodes in the computational graph that can be assigned to different devices for execution. In one implementation, partitioning circuitry 292 can allocate the operations represented by the nodes within each subgraph to an available computing device (e.g., CPU 280 or an accelerator 290). In specific setups, this assignment considers the computational capacity of the computing device required to execute the operations denoted by the nodes in the subgraph. In another implementation, the client's request can also contain user-specified data identifying a specific device type to handle operations for particular nodes.

In one implementation, the partitioning circuitry 292 creates a distribution of the computational graph among multiple devices, assigning each node in the computational graph to a corresponding device from the available devices. Each subgraph comprises a specific set of nodes from the computational graph, and as mentioned earlier, these nodes can be designated to the same device. In one instance, subgraphs could be allocated to GPU 205 and CPU 280, e.g., present in either different machines or the same machine. In one example, GPU 205 and CPU 280 can execute the operations represented by the nodes within the subgraph assigned to them. Further, computational graphs can also be distributed to FPGAs, ASICs, or other accelerators tailored for neural network tasks.

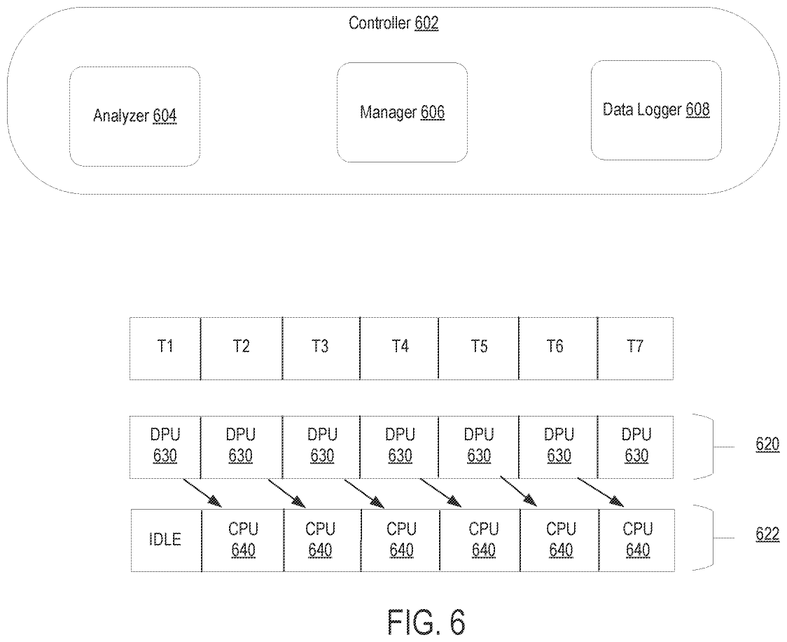

In an implementation, for a graph originally partitioned into a subset of subgraphs, one or more subgraphs can be executed on the GPU 205 or custom accelerator (e.g., DPU) 290 and the other subgraphs are executed on a CPU 280. In an implementation, when the accelerator 290 executes tasks for a first subgraph, the CPU 280 remains idle. However, once the tasks for the subgraph assigned to the accelerator 290 are complete, the CPU 280 can execute the second subgraph and perform other postprocessing operations, like accuracy computation. After both the accelerator 290 and the CPU 280 complete their respective tasks, for the next batch of tasks, both devices run in parallel in a pipelined fashion (detailed in FIG. 6).

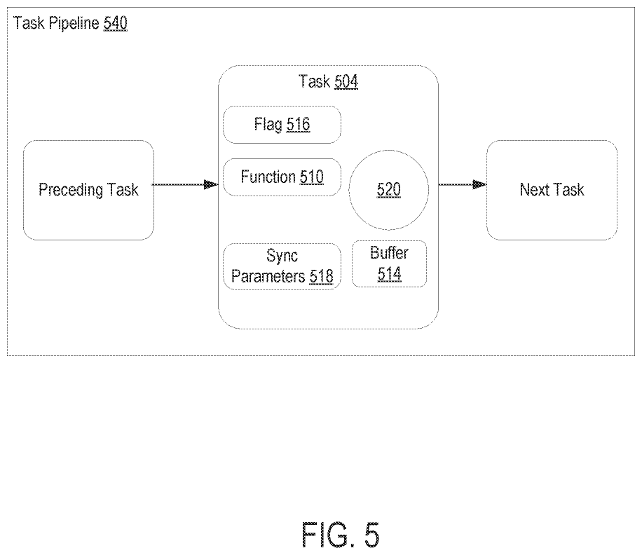

In one implementation, based on the current pipeline of tasks and the execution of these tasks by the accelerator 290 and the CPU 280, the partitioning circuitry 292 can determine whether a repartitioning condition is triggered for repartitioning the graph. In an implementation, the partitioning circuitry 292 uses one or more metrics to determine whether a graph repartitioning condition has occurred. For example, if a given task takes longer to execute than all other tasks in a task pipeline, the graph is repartitioned to provide the given task with a smaller subgraph during the next pipeline. In another implementation, if the CPU 280 has a longer idle time, then a given subgraph assigned to the CPU 280 is dynamically configured to run more nodes than originally assigned in order to avoid excess idle time on the CPU 280. These and other possible implementations for initiating repartitioning of graphs to update subgraphs (or generate additional subgraphs) are described with respect to FIGS. 5-8.

In an implementation, different partition strategies are used by the partitioning circuitry 292 to partition and repartition graphs (e.g., based on different operational capabilities of the computing devices assigned to execute these graphs). Further, graph repartitions can also be initiated when offline inferencing is non-optimal in certain scenarios. The partitioning circuitry 292 can repartition graphs, in real-time, based on changing workloads. For example, one partitioning may done when the CPU is idle, but a different partitioning (repartitioning) performed due to the CPU 280 now being busy. Further, parallel workloads (for example, a system that runs multiple machine learning models in parallel) and dynamic workloads (for example, a system that performs regular model retraining in conjunction with inference) can result in triggering of graph repartitioning by the partitioning circuitry 292.

The solutions presented herein, in one or more implementations, allow for the iterative identification of a possible graph partitioning strategies for a heterogeneous computing architecture based on real-time analysis of model performance. Further, prioritizing between power-efficient and performance modes using repartitioning of graphs in real-time can also be realized. In changing runtime environments, the solutions presented herein allow for graph repartitioning in environments where computing resources and devices are constantly changing based on changing workloads, e.g., in data center scenarios. Further, the extent to which various computing devices are used in a heterogeneous environment can be controlled.

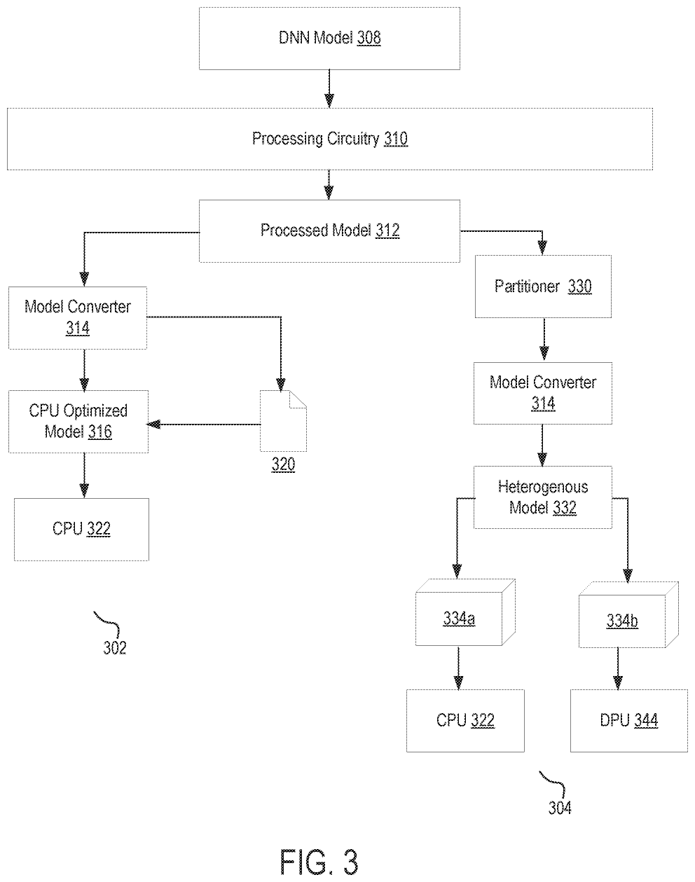

FIG. 3 is an example flow diagram illustrating processing of neural network models for execution on one or more computing devices. As depicted in the lefthand side of the figure, a first flow diagram 302 illustrates processing a neural network using a converter to configure the neural network for execution using a CPU. On the righthand side of the figure, another flow diagram 304 is depicted that details configuring a neural network using a combination of partitioners and converters, such that the neural network can be executed in a heterogenous environment using different computing devices, such as a CPU, and a GPU, or an accelerator.

In the flow diagram 302, a given neural network model, e.g., a deep neural network (DNN) model 308 is processed using a processing circuitry 310 to configure the DNN model 308 to run on specific hardware implementations, e.g., CPU or FPGA-based hardware platforms. In an implementation, the processing circuitry 310 can include various components such as compilers, quantizers, model libraries, and other tools for configuring the DNN model 308. It is noted that the functionalities of these components are not discussed in detail for the sake of simplicity. The processing circuitry 310 performs these functions in order to generate a version of the DNN model 308, i.e., to enable the execution of the DNN model 308 using a specific hardware component.

In one implementation, a processed DNN model 312, i.e., model 308 configured by the processing circuitry 310, is fed to a model converter 314. In one example, the model converter 314 is a tool (circuitry and/or software component) used to transform a machine learning model from one format to another. The primary purpose of the model converter 314 is to enable interoperability between different deep learning frameworks, allowing the model to be used and executed in various environments. In an implementation, the model converter 314 loads the processed model 312 and determines specifications such as model architecture, weights, and other necessary parameters associated with the processed model 312. The model converter 314 constructs an intermediate representation of the model 312 that can be interpreted and converted for a hardware-specific implementation.

In one implementation, the model converter 314 outputs a CPU optimized model 316, such that the CPU optimized model 316 is configured for CPU execution using a software framework 320 (e.g., ZenDNN™ framework developed by Advanced Micro Devices, Inc.). In an example, the framework 320 is designed to optimize the performance of neural network inference and training on specific hardware allowing for efficient execution of deep learning models on the CPU 322. One or more operations for the model 316, such as convolutions, matrix multiplications, and activation functions can be carried out on the CPU 322. In alternative implementations, optimized models can also be generated specifically for GPU or accelerator execution.

In some implementations, the model 308 is converted and optimized for hardware-specific execution (e.g., by the CPU 322 or an accelerator), when a different computing hardware is unable to perform one or more functions for the model 308. For example, in cases where an accelerator does not support a particular operation, but the operation can be performed using the CPU 322, the model 308 is optimized for execution by the CPU 322. For example, certain operations including control flow operations and branching and conditional operations are performed using CPU capabilities and therefore the model 308 can be optimized for CPU 322 execution. Alternatively, similar optimizations can be performed, e.g., when accelerators, such as GPUs, FPGAs, and ASICs are preferred over CPUs for specific operations in neural networks due to their highly parallelized and specialized hardware design. For example, operations such as matrix multiplication and convolution, activation functions, large batch training, etc., can be performed using accelerators instead of CPU 322.

However, most modern CPUs possess advanced computational power and are highly efficient, especially for DNN model workloads. The execution of DNN model using techniques described in flow diagram 302 does not exploit the opportunities for heterogeneous computing between distinct hardware devices, e.g., the CPU 322 and one or more accelerators or GPUs.

The flow diagram 304, on the righthand side of the FIG. 3, illustrates an approach for optimizing neural network model 308 in such a way that it better exploits the capabilities of a heterogenous computing environment. In an implementation, the model 312 (e.g., represented by a computational graph) is processed by a partitioner 330 (e.g., partitioning circuitry 292 described in FIG. 2) to partition the model 312 into two or more subgraphs. In one implementation, each subgraph is created for a specific hardware machine execution. In the particular example shown in the figure, a first subgraph is created for the CPU 322 and another subgraph is created for an accelerator, e.g., DPU 344. The model 308, as partitioned into its various subgraphs, is represented by the heterogenous model 332.

The heterogenous model 332 is then processed by the model converter 314 to transform the individual subgraphs for accelerated execution at the CPU 322 and the DPU 344, respectively. As shown, subgraph 334a includes nodes that are accelerated by optimizing the computation and execution of these nodes, i.e., they are tailored for execution on the CPU 322. For example, such operations may include floating point operations or sequences that have branch instructions likely to cause divergent and/or random execution patterns. Similarly, the subgraph 334b includes nodes that are accelerated for specific execution using the DPU 344. These operations may, for example, include processing that is amenable to parallel processing where a given operation is executed on multiple different sets of data. In one implementation, partitioning the model 308 to generate subgraphs 334a and 334b enables part of the model 308 to run on DPU 344 while other portions of the model 308 to run on the CPU 322.

In an implementation, the partitioning of the model 308 is performed by considering processes or tasks that run specific portions of the computational graph. Since different processes can independently run portions (i.e., subgraphs) of the graph on different devices, individual processes for individual device subgraphs can be created to exploit parallelism and heterogenous computing capabilities of the computing system.

In one implementation, partitioning of the model 308 is performed using heuristics such that each subgraph is associated with a device indicator (e.g., CPU 322, DPU 344, or other specified device) using a device-specific tag or identifier. Based on the device specific tag, each subgraph is “stitched” to other subgraphs with the same tags to create contiguous groups of subgraphs. That is, subgraphs to be executed on a given device are merged to create contiguous groups of subgraphs. Further, for each specific device type, the various nodes included in the group of subgraphs are replaced with device-specific operations. In an implementation, these operations include basic operations such as Create, Read, Update, and Delete (CRUD) operations. Other operations are possible and are contemplated. For example, the nodes of subgraphs associated with the CPU 322 are replaced with operations to be executed by the CPU 322. Similarly, the nodes of subgraphs associated with the DPU 344 are replaced with operations to be executed by the DPU 344. In an example, the nodes of the subgraphs associated with the CPU 322 are replaced with optimized operations to be executed by the CPU 322. In an implementation, instructions executing on the DPU 344 can include binary code, e.g., specially compiled to run on the DPU 344. The compilation produces a single binary object that is deployed to the DPU at runtime, and therefore, the subgraph is replaced with a single operation, referred to as a “DPUOp”, replacing nodes in the subgraph. When encountered, this custom operation loads the compiled binary from disk and executes it on the DPU 344.

In an implementation, on replacing the nodes with CPU or accelerator specific operations, each subgraph (or subgraph group) to be executed on a given hardware device is stored as a file (e.g., a Protocol Buffer, PB, file). In an example, these files are programming language-agnostic, platform-neutral and include structured data. The PB files can help define a schema for the data using any predefined programming language, and can further be translated to programming instructions in different programming languages to work with the defined schema. In an implementation, the stored PB files can be passed through a compiler (not shown) for performing additional optimization operations (e.g., quantization), before it can be executed by a designated device.

In one implementation, switching between various devices like CPU, GPU, and accelerators (as described in flow diagram 302) can lead to higher memory access latency between the devices and can therefore decrease overall performance of execution of the model 308. On the other hand, using heterogenous capabilities of the devices (described in flow diagram 304) can utilize specific heuristics-based partitioning strategies for assignment of tasks on different devices, thereby achieving efficient and accurate execution of the model 308 as a whole. In some examples, the heuristics can include brute-force partitioning, tail-end cuts, random cuts, MinCuts, and the like that are known in the art. Further, the described partitioning strategies can also be useful in efficiently running models having unevenly distributed compute workloads. The described method of partitioning can further provide end-user control in that user-defined degree of abstractions can be used to generate subgraphs.

In one implementation, using traditional methods for processing models, e.g., as described by the flow diagram 302, results in repeated switching of contexts, i.e., switching the execution of one portion of the model from a first computing device to a second computing device. In one example, context switching can occur each time a computing device (such as GPU) does not have the capability to perform an operation, responsive to which the operation is passed onto a different computing device (e.g., CPU). Using the CPU only for processing operations that are unsupported by accelerators, does not provide any performance benefits for the computing system as a whole. On the other hand, using methods as described with respect to flow diagram 304, enables intelligent partitioning of the model into subgraphs, such that the heterogenous capabilities of the CPU and accelerators can be exploited. For instance, using a “MinCut” heuristic to partition the model, the model is partitioned such that operations encountered before a first unsupported operation are included in a first subgraph that is tagged for accelerator execution. Thereon, every operation, whether supported by the accelerator or not can be assigned for CPU execution. In one implementation, this is done since moving data from one device to another (e.g., a GPU to the CPU, or a CPU to a DPU) can be expensive in terms of the time required to perform the memory transfer. Therefore, assigning subsequent operations to a single device can minimize the number of such switches between devices to obtain better overall throughput. These and other possible implementations of partitioning the model are described with respect to FIG. 6.

Turning now to FIG. 4, a block diagram illustrating partitioning of computational graphs of a neural network model is depicted. As described above with respect to FIG. 3, neural network models represented by computational graphs can be divided into subgraphs, each to be executed by a specific hardware device. For instance, any given graph can be divided into two or more subgraphs where each subgraph can be either executed on a CPU, GPU, or other accelerator. In one implementation, the subgraphs are generated based on heuristics in order to exploit parallelism in heterogenous computing systems (as described in FIG. 3).

As shown in the figure, a partitioning circuitry 402 includes a controller 404 and a partitioner 406. In an implementation, the controller 404 is at least configured to initiate the partitioner 406 at various intervals (which may be fixed, programmable, or otherwise variable), amongst performing other functions. In an implementation, the controller 404 is further configured to generate a task pipeline 410 for executing processes associated with a computational graph 408 representing a model. In the instance shown in the top-half of the figure, the controller 404 generates a pipeline 410, with two different tasks (task 414a and task 414b). For example, task 414a can be queued to read data (e.g., stored as a TensorFlow record or other format) from a disk or a local memory 420. Further, task 414b can be queued for the CPU 440, wherein the task is to compute accuracy of the model as represented by the computational graph 408. Other tasks are possible and are contemplated.

In one implementation, any time during the execution of the task pipeline 410, one or more operations or tasks can be encountered that are determined to be candidates for execution using specific hardware devices. Each time such tasks are encountered, the controller 404 initiates the partitioner 406, such that the partitioner 406 can generate subgraphs from the computational graph 408. In an implementation, each subgraph includes nodes from the graph 408 that represent the specific operations that are to be performed by specific hardware devices. Further, these subgraphs can be accelerated for execution on their respective devices.

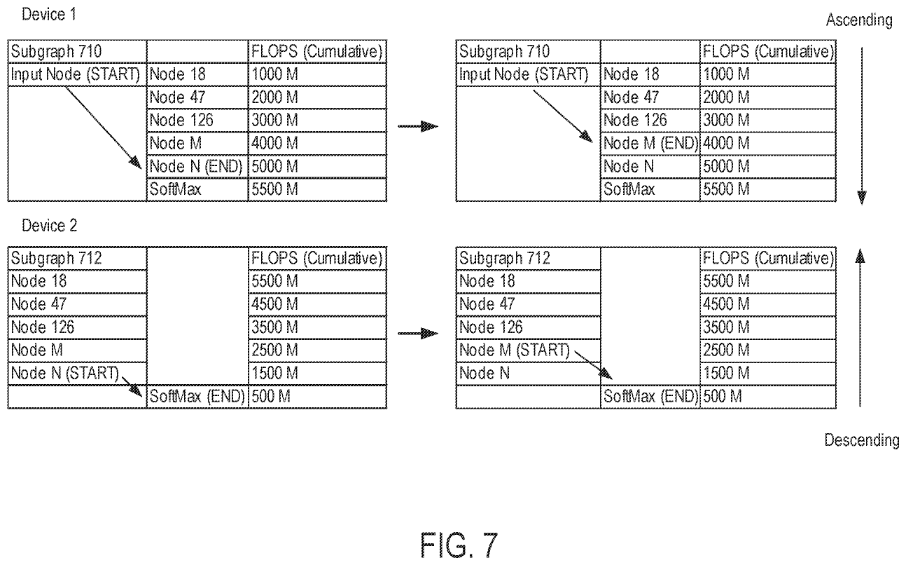

In the particular example shown in the bottom-half of the figure, pipeline 410 is updated for the graph 408, with two new subgraphs generated, one each for execution at an accelerator 416 and a GPU 418. As shown, task 414c is added to the pipeline 410, wherein the task 414c represents running the subgraph using the accelerator 416. Similarly, another task 414d is generated and queued in the pipeline 410, to be executed using the GPU 418. In an implementation, more tasks can be continually generated for the shown devices (or other devices) and added to the pipeline 410. Further, the controller 404 manages all the processes in the pipeline 404 and dynamically invokes the partitioner 406 at set intervals based on one or more parameters, when such tasks are encountered (described with respect to FIGS. 6 and 7).

FIG. 5 illustrates a block diagram illustrating task parameters for tasks in a pipeline. As described in the foregoing, each task is associated with a computational graph and is synchronized with other tasks in a task pipeline. That is, the output of one task is the input for the next task. Further, a buffer structure is programmed between each task to minimize device idle time.

In the example, tasks 504 in a pipeline 506 are synchronous, e.g., the output for preceding task is the input for task 504, and the output for task 504 is the input for the task following the task 504. In one implementation, a classification of each task 504 acts as a logical representation of a process. As described in the context of this disclosure, “task” is used to mean individual operations or nodes in a computational graph. These operations can range from simple arithmetic operations (e.g., addition, multiplication) to more complex operations (e.g., matrix multiplication, activation functions, etc.). Each task takes input tensors, performs computations, and produces output tensors. Further, “process” is used to describe computations that occur along the edges of the computational graph. These computations involve the flow of data (tensors) between different nodes (tasks). The data flows through the edges, and the computations at each edge can involve various mathematical operations or transformation. In the example shown in the figure, each task 504 is subclassed based on individual process-based tasks. For example, a task can include reading input data, executing a device subgraph, computing accuracy, and the like.

In one implementation, each task 504 includes a function 510 that represents or is otherwise indicative of the work performed by the task 504. Further, each task 504 maintains an input buffer 514, a flag 516, and synchronization parameters 518. In an implementation, each task 504 can be a producer and/or a consumer. In various implementations, the input buffer 514 maintained by a given task 504 is implemented in a circular work queue 520, with a pointer identifying the start of the queue 520, a pointer identifying the end of the queue 520, and the flag 516 set to active or inactive. The flag 516 is set based on whether a task preceding the current task 504 is currently producing work items or not producing work items. In one implementation, the synchronization parameters 518 include settings used to control the flow and coordination of tasks as they progress through a pipeline 540. Synchronization parameters 518 define order of tasks to be executed in the pipeline 540, taking coordination and dependencies into account. In some examples, the synchronization parameters 518 include dependency graphs, task execution order, task priority, buffering and queueing information, transaction management data, and the like.

During a lifecycle of the task 504, the flag 516 is first set to active, i.e., indicating that a task preceding the current task 504 is producing work items. However, the queue 520 is empty since the task 504 has not yet produced any results. The task 504 will not produce any results until a command is received from the producing (i.e., preceding) task. When the producing task polls the task 504, the task 504 sends the producing task an accept signal, since the queue 520 is empty. The task 504 then receives data from the producing task. The producing task continues to produce and transfer data into the queue 520. The task 504 monitors the state of the queue 520 as it consumes data.

In one implementation, if the producing task produces more data than the task 504 can consume, task 504 sends a wait signal to the producing task. During this time, the producing task pauses production of new data. After a predefined period (e.g., 100 MS), the producing tasks again polls the task 504, and upon receiving an accept signal, restarts producing data for the task 504 to consume. Once the program is over, i.e., the producing task has no more data to produce, it sends a signal to task 504 to deactivate the flag 516 and terminate connection. Similarly, when the queue 520 for the task 504 is empty, it sends a signal to the next task to set its flag to deactivate. This process can be continued for each task in the pipeline 506. Ultimately, all active processes terminate and the control returns to a controller (e.g., controller 404 of FIG. 4). The controller can then make decisions, based on one or more factors, to update the pipeline by repartitioning the computational graph (detailed in FIG. 6).

FIG. 6 depicts a block diagram illustrating adaptive graph repartitioning of a computational graph. In the context of Machine Learning (ML), devices like CPUs are commonly used for inference and can be paired with accelerators for performing specific functions related to a neural network model. In most cases, the CPU acts as a fallback option when the accelerator does not support a particular operation. However, server CPUs possess exceptional computational power and are highly efficient on Deep Neural Network (DNN) workloads. This creates an opportunity for exploitation of heterogeneous computing between devices. In one implementation, parallelization of the model is one way by which this computational power can be utilized, e.g., some parts of the model running on accelerators while other portions running on the CPU, executed in a pipelined fashion.

As described in the foregoing, partitions of a computational graph can be generated. In one implementation, the partitions are generated to create subgraphs, where each subgraph contains one or more nodes from the original computational graph. This involves creating a specific subgraph for each identified node group. The operations represented by the nodes within each subgraph can be allocated to an appropriate computing device for processing, from available devices in a heterogenous computing environment.

In one implementation, when executing these partitions using specific computing devices, measured idle time of different computing devices and overall availability of system resources can change over time. For example, idle times can change for a CPU when waiting for data transfers, I/O operations, synchronization, or during periods when the CPU is not utilized fully. Similarly, computing resource availability can also change for accelerators processing one or more nodes of a subgraph. Further, in some applications, different combinations for performance and power can be required during execution of the various partitions of the graph. For example, based on varying input load levels for a given device, the amount of power consumed by the device can change. Further, some operations can require higher power consumption in order to maintain a desired level of performance.

In some implementations, a strategy used for partitioning a graph can work adequately for a specific device (e.g., CPU) but not for other devices (e.g., GPU). Further, a strategy for partitioning the graph tailored specifically for offline inferencing of the model, might not be optimal for other scenarios. Constantly changing workloads, execution of multiple models in parallel, and other dynamic parameters, can often require repartitioning of the computational graph, in real-time based on changing system parameters, to update originally created subgraphs and/or to create additional subgraphs.

In an implementation, adaptive graph repartitioning includes repartitioning a computational graph that includes nodes representing various operations for a neural network model, e.g., responsive to a repartitioning condition. As described earlier, various nodes of the graph can be grouped into a subgraph during initial partitioning of the graph. Each such subgraph can be assigned to a specific computing device for execution. In one implementation, dynamic re-adjustment of the graph partitions can be required to better distribute load (load balance) between devices (CPUs and accelerators), e.g., for different conditions such as exploiting different device strengths, minimizing the idle time of the devices, and generating different partition configurations. The repartitioning is performed without halting the inference server and continuously improving the efficiency.

As shown in FIG. 6, a controller 602 (similar to controller 404 described in FIG. 4) is configured to repartition a computational graph based on one or more conditions. The controller 602 includes an analyzer 604, a manager 606, and a data logger 608. In one implementation, analyzer 604 is configured to monitor and analyze incoming work items associated with various tasks of the computational graph to identify a total load on each computing device executing various subgraphs of the computational graph. For example, the analyzer 604 ascertains the tasks queued for a CPU and one or more accelerators, and determines a cumulative system load. The analyzer 604 is further configured to analyze the system workload based on number of total operations, high-precision and low-precision operations queued for a given device, and one or more other operations (e.g., model retraining, accuracy computation, etc.) performed by a device. In one implementation, the manager 606 is configured to create task pipelines based on commands from the analyzer 604. The manager 606 is also configured to manage synchronization between tasks in the pipeline and overall task management. Further, data logger 608, records various states of the computing devices executing tasks in the task pipeline and also stores other important information in one or more databases.

In an implementation, deep learning workloads represented as computational graphs are partitioned using graph cuts in order to distribute the workloads to multiple computing devices. As shown in an example in the bottom-half of the figure, in a ‘min cut’ partition configuration, a graph is partitioned into two subgraph—the first subgraph 620 running on a GPU or custom accelerator (DPU 630) and the other subgraph 622 running on a CPU 640. When the DPU 630 runs for the first time (T1), the CPU 640 may remain idle. However, once the task at time T1 is completed by the DPU 630, the output of the task is input to the CPU 640 in the pipeline. Subsequently (time periods T2 to T7), both the DPU 630 and the CPU 640 run in a parallel fashion, i.e., each task output produced by the DPU 630 acts as an input for the next task to be executed by the CPU 640.

In an implementation, the controller 602 utilizes metrics generated by the analyzer 604 to determine whether a partitioning circuitry (e.g., partitioning circuitry 292 of FIG. 2) is to be invoked to repartition the computational graph. Responsive to such a condition, the computational graph is dynamically re-partitioned in real-time to update the originally generated subgraphs (or create new subgraphs). In an implementation, the condition for repartitioning can be triggered based on parameters such as the number of floating-point operations per second (FLOPS), and a number of total operations for a given subgraph. In an implementation, the repartitioning can also be performed based on device heuristics such memory access time, memory-intensive operations identifiers, device configuration, and workload associated with each device. Other examples include number of cores, memory bandwidth, cache size, and performance per watt, and the like.

For example, when a given task takes more than a predetermined threshold amount of time to execute than other tasks in the pipeline, the graph can be repartitioned such that a smaller subgraph (i.e., subgraph with lesser number of nodes than other subgraphs) is assigned to the given task in the next pipeline. A specific example of repartitioning using FLOPS and number of nodes is described in FIG. 7. In an implementation, the graph repartitioning is performed, in real-time, based on a generated table including all potential combinations of number of nodes in a graph, number of operations, and number of FLOPS. Other considerations such as idle time, types of operations, changing workloads, etc. can also be used as a basis for invoking the partitioning circuitry to dynamically repartition the graph. In another implementation, the table (which can be pre-computed or otherwise) can be periodically updated based on one or more runtime characteristics that are detected for each device. Based on the updated table, the start nodes and end nodes of a subgraph can be adjusted, i.e., the subgraph can be expanded or collapsed, when a repartitioning condition is next encountered. In an alternative implementation, additional smaller or larger subgraphs can also be generated.

In one implementation, each different computing device (i.e., the CPU 640 and DPU 640) can use device-specific heuristics to execute work items associated with their assigned subgraphs. That is, each of the CPU 640 and the DPU 630 have individually generated tables and heuristic parameters that are used when a condition for repartitioning the graph occurs. Based on the best-policy identified for a given device, i.e., a repartitioning strategy that is best suited for a device, the repartitioning strategy is replicated for all like devices. For example, specific operations of a certain size can be allocated for execution to a particular device to achieve maximum throughput. For instance, a first device can be best suited to perform 3×3 convolutions, whereas a second device can be best suited to perform 5×5 convolutions. In another example, in terms of memory usage, a given device can perform best when all data is kept within a certain range, e.g., 100-150 MB. This range can be determined autonomously by the partitioning circuitry after a specific number of execution cycles. In yet another example, in terms of power usage, a first device can perform a first operation with less power than a second device, however the second device can perform a second operation using less power than the first device. The best-policy can be identified by the partitioning circuitry based on these operational parameters and the best-policy is applied across similar devices. Other implementations are contemplated.

The techniques for updating computational graph partitions dynamically and in real-time allows for the iterative identification of the best possible graph partitioning strategy for a heterogeneous model graph based on real-time analysis of model performance. Further, repartitioning can be based on different operational modes, such as power-efficiency mode and performance mode, using a pre-computed table and device heuristics. The solutions presented herein also for graph repartitioning in environments where compute resources and devices are constantly changing based on changing workloads, e.g., in data center scenarios. This can further provide control over the extent to which various devices are used in a heterogeneous environment.

Turning now to FIG. 7, an example of adaptive graph repartitioning based on floating-point operations per second (FLOPS), is illustrated. In the example shown in the figure, a min-cut graph is initially partitioned into subgraphs based on number of FLOPS associated with the graph. Each subgraph can be individually assigned to different devices, e.g., CPU or accelerators. As shown, one device is executing a first subgraph 710 including an input node to node N of the graph, wherein each node comprises of a specific number of FLOPS. For example, node 18 has 1000 million (M) FLOPS, node 47 has 2000 M FLOPS, and so on. Similarly, device 2 is executing a second subgraph 720 including node N to an end node (e.g., node executing a SoftMax operation) of the graph.

In response to a repartitioning condition, a controller (e.g., controller 602 of FIG. 6) triggers repartitioning of the graph, e.g., by adjusting the proportions of the subgraphs 710 and 720. For example, if device 2 has a longer idle time that device 1, then the first subgraph 710 is adaptively adjusted to execute nodes 1 to node M (as opposed to node 1 to node N), and subgraph 720 is adjusted to execute node M to SoftMax (as opposed to node N to SoftMax). This way, the number of FLOPS for the second subgraph 720 is increased from 500 M to 2500 M, thereby increasing usage of the device 2. This can utilize the idle time of the device 2 more efficiently than what is possible when the second graph 720 is executed as originally partitioned. Further, the usage for the device 1 is reduced, since the number of FLOPS for the first graph 710 are adjusted from 5000 M to 4000 M. This can further render more computational power available at device 1 to perform other operations.

It is noted that FIG. 7 merely describes an example of graph repartitioning based on number of FLOPS for a given subgraph. However, in other implementations, other strategies can be used to repartition the graph when a repartitioning condition is encountered. In an example, some of the other strategies can include repartitioning the graph based on operation type, device configuration, performance or power modes, and the like. Some of these strategies have been described in the foregoing. Other strategies are possible and are contemplated.

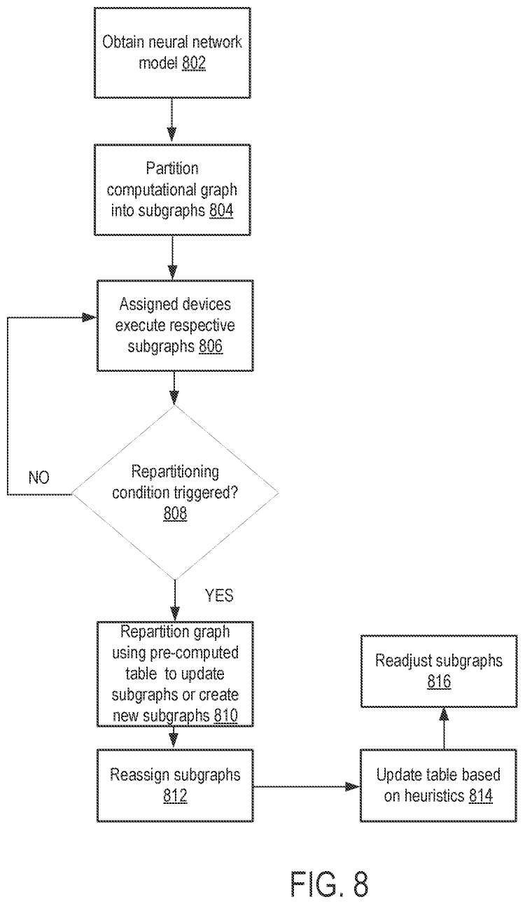

FIG. 8 illustrates an example method for adaptive repartitioning of computational graphs representing a neural network model. As described earlier, adaptive graph repartitioning includes repartitioning a computational graph that includes nodes representing various operations for a neural network model, e.g., responsive to a repartitioning condition. Various nodes of the graph can be grouped into a subgraph during initial partitioning of the graph, e.g., to execute each subgraph at a different computing device. In one implementation, dynamic re-adjustment of the graph partitions can be required to better distribute load between the computing devices (e.g., CPUs and accelerators), for different conditions such as exploiting different device strengths, minimizing the idle time of the devices, and generating different partition configurations. The repartitioning is performed without halting the inference server and continuously improving the efficiency.

In an implementation, processing circuitry obtains a neural network model from a model library or a model zoo (block 802). In one example, the neural network model is a model based on any given framework such as TensorFlow or PyTorch platforms. The neural network model comprises nodes representing a unit or processing element within the neural network. Each node represents individual operations to be performed for processing the neural network. The neural network model is represented using a computational graph to represent the computations performed by the neural network model. The computational graph can be a directed acyclic graph where nodes represent operations or computations, and edges represent the data or tensors flowing between these operations.

In an implementation, the processing circuitry divides the computational graph into multiple subgraphs, each consisting of one or more nodes from the original computational graph (block 804). In certain scenarios, these subgraphs can be generated by dividing pairs of nodes in the computational graph, that can be assigned to different computing devices for execution. In one implementation, the operations represented by the nodes within each subgraph can be allocated to an available computing device (e.g., CPU or an accelerator). In specific setups, this allocation considers the computational capacity of each computing device, required to execute the operations denoted by the nodes in the subgraphs. In another implementation, user-specified data identifying a specific device type to handle operations for particular nodes can also be a basis for partitioning the graph. Each computing device executes its assigned subgraph (block 806).

During execution, the processing circuitry determines whether a repartitioning condition is encountered (conditional block 808). In one implementation, the repartitioning condition is encountered when a given task (represented by a node) takes longer to execute than all other tasks in a task pipeline. In another implementation, if a computing device has a longer idle time, then a given subgraph assigned to the device needs to be adjusted to run additional nodes than originally assigned, in order to utilize the idle time of the device efficiently. Other repartitioning conditions as described in the foregoing are possible.

If a repartitioning condition is not encountered (conditional block 808, “no” leg), the originally generated subgraphs are continually executed by the computing devices they have been assigned to, e.g., until all operations are complete and all processes terminate. However, if a repartitioning condition is encountered (conditional block 808, “yes” leg), the processing circuitry repartitions the computational graph to adjust the originally generated subgraphs and/or to create additional subgraphs (block 810). In an implementation, the graph repartitioning is performed, in real-time, based on a pre-computed table including many (or all) potential combinations of number of nodes in a subgraph, number of operations, and number of FLOPS. Other considerations such as idle time, types of operations, changing workloads, etc. can also be used as a basis for dynamically repartitioning the graph. The updated subgraphs are reassigned to specific computing devices (block 812).

In an implementation, the pre-computed table can be periodically updated based on one or more heuristics (block 814). The heuristics can include the heuristic parameter is indicative of one or more of memory access times, matrix sizes, memory-intensive operation identifiers, device configurations, and workload data associated with one or more computing devices of the plurality of computing devices. Based on the updated table, the start nodes and end nodes of a subgraph can be adjusted at a time when the graph is next repartitioned (block 816) (e.g., when another repartitioning condition is encountered). In an alternative implementation, additional smaller or larger subgraphs can also be generated based on the updated table.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to
partition a computational graph representing a neural network into two or more subgraphs;
assign each of the two or more subgraphs to a different computing device of a plurality of computing devices for execution; and
dynamically repartition the computational graph such that one or more tasks associated with a subgraph assigned to a computing device of the plurality of computing devices is assigned to a different computing device.

2. The processor as claimed in claim 1, wherein the circuitry is configured to partition the computational graph during execution of one or more tasks of a plurality of tasks by the plurality of computing devices, and wherein each of the two or more subgraphs corresponds to at least one task of the plurality of tasks.

3. The processor as claimed in claim 1, wherein the circuitry is configured to repartition the computational graph, based at least in part data corresponding to start nodes and end nodes of each of the two or more subgraphs.

4. The processor as claimed in claim 1, wherein the circuitry is configured to dynamically repartition the computational graph, responsive to data indicative of one or more of memory access times, matrix sizes, memory-intensive operation identifiers, device configurations, execution times, idle times, and load associated with one or more computing devices of the plurality of computing devices.

5. The processor as claimed in claim 3, wherein repartition the computational graph, the circuitry is configured to update a start node and end node for each subgraph.

6. The processor as claimed in claim 1, wherein the plurality of computing devices comprise at least a central processing unit and a parallel processor, and the circuitry is configured to partition the computational graph such that a subgraph assigned to the central processing unit does not include operations unsupported by the central processing unit.

7. The processor as claimed in claim 6, wherein the circuitry is configured to dynamically repartition the computation graph based at least in part on a load on the central processing unit and the parallel processor.

8. A method comprising:
partitioning a computational graph representing a neural network into two or more subgraphs;
assigning each of the two or more subgraphs to a different computing device of a plurality of computing devices for execution; and
dynamically repartitioning the computational graph such that one or more tasks associated with a subgraph assigned to a computing device of the plurality of computing devices is assigned to a different computing device.

9. The method as claimed in claim 8, wherein the partitioning the computational graph during execution of one or more tasks of a plurality of tasks by the plurality of computing devices, and wherein each of the two or more subgraphs corresponds to at least one task of the plurality of tasks.

10. The method as claimed in claim 8, further comprising repartitioning the computational graph, based at least in part data corresponding to start nodes and end nodes of each of the two or more subgraphs.

11. The method as claimed in claim 10, further comprising dynamically repartitioning the computational graph, responsive to data indicative of one or more of memory access times, matrix sizes, memory-intensive operation identifiers, device configurations, execution times, idle times, and load associated with one or more computing devices of the plurality of computing devices.

12. The method as claimed in claim 11, further comprising updating a start node and end node for each subgraph as part of the repartitioning.

13. The method as claimed in claim 8, wherein the plurality of computing devices comprise at least a central processing unit and a parallel processor, and the method comprises partitioning the computational graph such that a subgraph assigned to the central processing unit does not include operations unsupported by the central processing unit.

14. The method as claimed in claim 13, further comprising dynamically repartitioning the computation graph based at least in part on a load on the central processing unit and the parallel processor.

15. A system comprising:
a plurality of computing devices comprising at least a central processing unit and a parallel processor; and
a processor comprising circuitry configured to:
partition a computational graph representing a neural network into two or more subgraphs;
assign each of the two or more subgraphs to a different computing device of a plurality of computing devices for execution; and
dynamically repartition the computational graph such that one or more tasks associated with a subgraph assigned to a computing device of the plurality of computing devices is assigned to a different computing device.

16. The system as claimed in claim 15, wherein the processor is configured to partition the computational graph during execution of one or more tasks of a plurality of tasks, and wherein each of the two or more subgraphs corresponds to at least one given task from the plurality of tasks.

17. The system as claimed in claim 15, wherein the processor is configured to modify at least two subgraphs of the two or more subgraphs, based at least in part on data corresponding to start nodes and end nodes of each of the at least two subgraphs.

18. The system as claimed in claim 15, wherein the processor is configured to repartition the computation graph based at least in part on one or more of floating point operations per second, memory access time, small matrix sizes, memory-intensive operations, and computing device configuration.

19. The system as claimed in claim 15, wherein the processor is configured to partition the computation graph such that at least one subgraph includes at least one operation not supported by the central processing unit and a second subgraph includes at least one operation not supported by the parallel processor.

20. The system as claimed in claim 15, wherein the processor is configured to dynamically repartition the computational graph based at least in part on a load on the central processing unit and the parallel processor.
